(19) United States
(12) Patent Application Publication
(10) Pub. No.: US 2026/0201980 A1
(43) Pub. Date: Jul. 16, 2026

(54) FITTING STABILIZER ASSEMBLY

(71) Applicant: Coffman Custom Machine, LLC, Grain Valley, MO (US)

(72) Inventor: Joseph Coffman, Grain Valley, MO (US)

(73) Assignee: Coffman Custom Machine, LLC, Grain Valley, MO (US)

(21) Appl. No.: 19/429,490

(22) Filed: Dec. 22, 2025

Related U.S. Application Data
(60) Provisional application No. 63/738,235, filed on Dec. 23, 2024.

(51) Int. Cl. F16L 3/12; F16L 3/237; F16L 5/00

(52) U.S. Cl. CPC F16L 3/1222; F16L 3/1218; F16L 3/237; F16L 5/00

(57) ABSTRACT

A conduit coupler securement assembly includes a first bracket and a second bracket. The first bracket includes one or more first support walls that are positioned in closely spaced relation to a first portion of one or more coupling assemblies that connect one or more conduits to a machine. The second bracket includes one or more second support walls that are positioned in closely spaced relation toa second portion of the one or more coupling assemblies. One or more spacers extend between the first bracket and the second bracket such that the one or more first support walls position the first portion in engagement with the second portion that is positioned by the one or more second support walls. A coupling bolt extends through a mounting boss of the second bracket to secure the conduit coupler securement assembly to the machine.

### CROSS-REFERENCE TO RELATED APPLICATIONS

This application claims the benefit of U.S. Provisional Patent Application No. 63/738,235, filed December 23, 2024, the disclosure of which is hereby incorporated herein in its entirety by reference.

### BACKGROUND OF THE INVENTION

### Field of the Invention

This disclosure relates generally to a fitting stabilizer. More specifically, this disclosure relates to a piping or hose coupler stabilizer that supports one or more coupling assemblies that connect one or more conduits to a machine.

### Background

Conduits are used to supply fluids to a manufacturing process. The fluids may be used to produce a product or to support the manufacturing process, such as for cooling. Couplers or fittings used to connect the conduits to the machine are subject to deterioration or wear, especially if the conduits are subjected to repetitive movement. For example, in an injection stretch blow mold machine, molds for plastic products move vertically and around a vertical central axis at high rates of speed. The conduits carrying cooling water to the molds move with the molds, and quick connect fittings that connect the conduits to the molds undergo wear due to the repetitive movement of the conduits relative to the molds and torquing of the conduits, especially at the fittings, due to the movement. It is necessary to replace the fittings due to wear to prevent leaks or other issues. A solution is needed to prevent such wear to the fittings.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

The embodiments described herein relate to a fitting stabilizer assembly for securing one or more conduits to a machine, the fitting stabilizer assembly including: a first bracket that supports a first portion of one or more coupling assemblies, the one or more coupling assemblies connecting the one or more conduits to the machine; a second bracket that supports a second portion of the one or more coupling assemblies; a coupling connector on one of the first bracket or second bracket and connectable to the machine; wherein: the first bracket supports the first portion of the one or more coupling assemblies in alignment with the second portion of the one or more coupling assemblies.

The embodiments described herein relate to a fitting stabilizer assembly, further including one or more spacers that position the first bracket in spaced relation relative to the second bracket.

The embodiments described herein relate to a fitting stabilizer assembly, wherein the first bracket includes one or more first support walls each having a first bore formed therethrough, and the one or more first support walls are positionable such that the first portion of the one or more coupling assemblies extends within the first bore of a respective one of the one or more first support walls.

The embodiments described herein relate to a fitting stabilizer assembly, wherein the second bracket includes one or more second support walls each having a second bore formed therethrough, and the one or more second support walls are positionable such that the second portion of the one or more coupling assemblies extends within the second bore of a respective one of the one or more second support walls.

The embodiments described herein relate to a fitting stabilizer assembly, wherein the coupling connector is removably securable to the machine for securing the fitting stabilizer assembly to the machine.

The embodiments described herein relate to a fitting stabilizer assembly, wherein the second bracket includes a mounting boss through which the coupling connector extends.

The embodiments described herein relate to a fitting stabilizer assembly, wherein the first bracket is formed with one or more first bores that have a first diameter greater than a second diameter of one or more second bores formed in the second bracket.

The embodiments described herein relate to a fitting stabilizer assembly for securing male and female couplers for coolant supply and return conduit relative to a machine, the fitting stabilizer assembly including: a first bracket having first and second first bracket bores formed therein, the first and second first bracket bores each surrounded by a first bracket support wall and having a diameter sized to snugly receive one of the male couplers therein; a second bracket having first and second second bracket bores formed therein the first and second second bracket bores each surrounded by a second bracket support wall and having a diameter sized to snugly receive one of the female couplers therein; a coupling connector on the fitting stabilizer assembly and connectable to the machine; and at least one connector for connecting the first bracket to the second bracket such that the first bracket bores in the first bracket are axially aligned with the second bracket bores in the second bracket

The embodiments described herein relate to a fitting stabilizer assembly, further including one or more spacers that position the first bracket support walls in spaced relation relative to the second bracket support walls.

The embodiments described herein relate to a fitting stabilizer assembly, further including a mounting boss extending from the fitting stabilizer assembly, wherein the coupling connector extends through the mounting boss.

The embodiments described herein relate to a fitting stabilizer assembly, wherein the first and second first bracket bores have a first diameter that is greater than a second diameter of the first and second second bracket bores.

The embodiments described herein relate to a fitting stabilizer assembly for securing one or more conduits to a machine, the fitting stabilizer assembly including: a lower bracket that includes one or more first support walls each positionable in closely spaced relation to a first portion of one or more coupling assemblies connected to the one or more conduits; an upper bracket that includes one or more second support walls each positionable in closely spaced relation to a second portion of the one or more coupling assemblies; and one or more spacers extending between the lower bracket and the upper bracket, wherein a spacing maintained by the one or more spacers between the lower bracket and the upper bracket corresponds to a coupling assembly spacing between the first portion and the second portion of the one or more coupling assemblies.

The embodiments described herein relate to a fitting stabilizer assembly, further including a coupling bolt extending from the fitting stabilizer assembly for securing the fitting stabilizer assembly to the machine.

The embodiments described herein relate to a fitting stabilizer assembly, wherein the one or more first support walls of the lower bracket form one or more first bores within which the first portion of the one or more coupling assemblies is supported.

The embodiments described herein relate to a fitting stabilizer assembly, wherein the one or more second support walls of the upper bracket form one or more second bores within which the second portion of the one or more coupling assemblies is supported.

The embodiments described herein relate to a fitting stabilizer assembly, wherein the first portion and the second portion of the one or more coupling assemblies are supported in coupling relationship.

The embodiments described herein relate to a fitting stabilizer assembly, further including a mounting boss extending from the upper bracket for securing the fitting stabilizer assembly to the machine.

### BRIEF DESCRIPTION OF THE DRAWINGS

Embodiments of the invention are described in detail below with reference to the attached drawing figures, wherein:

FIG. 1 shows a front perspective view of an embodiment of a fitting stabilizer assembly that includes a lower bracket and an upper bracket for supporting two coupling assemblies.

FIG. 2 is a front view of the embodiment of the fitting stabilizer assembly shown in FIG. 1. The fitting stabilizer assembly is shown attached to a base pedestal of a molding machine

such that the fitting stabilizer assembly, and the two coupling assemblies supported therein, move with the base pedestal.

FIG. 3 is a front and bottom perspective view of the lower bracket of the fitting stabilizer assembly shown in FIG. 1.

FIG. 4 is a top perspective view of the lower bracket of the fitting stabilizer assembly shown in FIG. 1.

FIG. 5 is a rear and top perspective view of the upper bracket of the fitting stabilizer assembly shown in FIG. 1.

FIG. 6 is a front and bottom perspective view of the upper bracket of the fitting stabilizer assembly shown in FIG. 1.

The drawing figures do not limit the invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

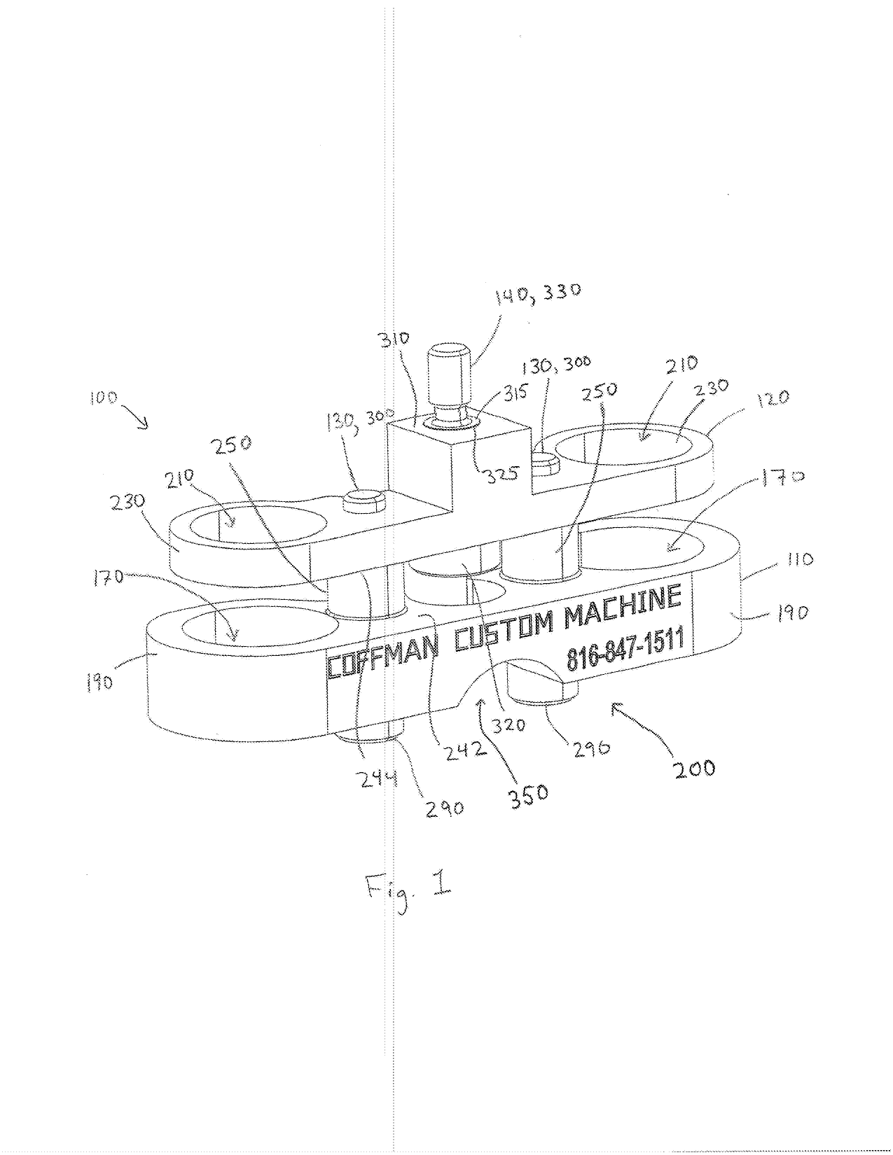

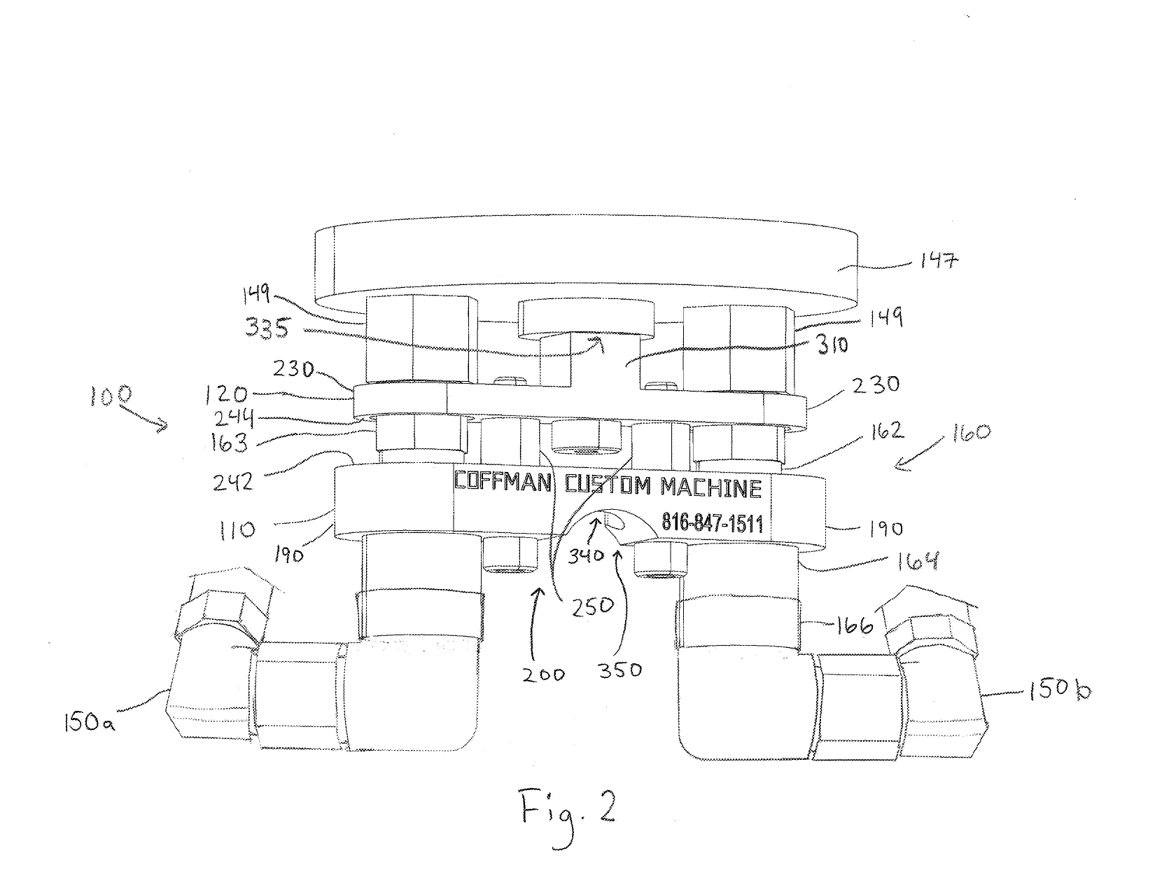

In an embodiment shown in FIG. 1, a conduit clip or fitting stabilizer assembly 100 includes a first or lower bracket 110 and a second or upper bracket 120. One or more fasteners or couplers 130, two in the embodiment shown, secure the first bracket 110 to the second bracket 120. A coupling bolt or positioning pin 140 extends from the second bracket 120 to secure the fitting stabilizer assembly 100 to a bottom surface of a base pedestal 147 (see FIG. 2) of a machine, such as, for example, a molding machine that utilizes a coolant supply during use. The fitting stabilizer assembly 100 is configured to support or stabilize one or more coolant hoses or conduits 150, which comprise one or more various fittings and flexible piping, extending therethrough that supply fluids to or drain fluids away from the machine. In the embodiment shown in FIG. 2, the fitting stabilizer assembly 100 is secured to the base pedestal 147 and supports and secures one or more coupling assemblies or conduit couplers or quick connect fittings 160 that couple the one or more conduits 150 to the machine via connecting components 149. In an embodiment, the connecting components 149 advance the conduits 150 that supply the fluid through the base pedestal 147, but it is contemplated that the conduits 150 could be alternatively connected to the machine. The connecting components 149 may also support the fitting stabilizer assembly 100 spaced a distance from the base pedestal 147. The fitting stabilizer assembly 100 is secured to the machine such that the fitting stabilizer assembly 100, and the one or more coupling assemblies 160 supported therein, move with the base pedestal 147 during a manufacturing process. In an embodiment, a first conduit 150a and a second conduit 150b are coupled to the machine via the quick connect fittings 160, and the first conduit 150a is a water supply line that supplies water to cool a mold in a molding machine and the second conduit 150b is a water return line that drains water away from the mold in the molding machine.

The quick connect fitting 160 is known in the art and includes a male coupler or male plug 162 having an adapter or fitting 163 that is connected to an entry or exit port of the machine and a female coupler 164 connected to a conduit 150. Within the female coupler 164, a locking mechanism (not shown), such as a plurality of ball bearings, a collet, or a similar device, engages the male plug 162 to selectively secure the male plug 162 within the female coupler 164. A seal, such as an O-ring, may be positioned within the female coupler 164 to provide a sealing relationship between the female coupler 164 and the male plug 162. A release mechanism 166, such as a ring or button extending from the female coupler 164, is engageable to retract the locking mechanism and release the male plug 162 from the female coupler 164. In an embodiment, the release mechanism 166 includes a textured sleeve that is easily gripped by hand or otherwise engaged, and when the release mechanism 166 is pulled or rotated, the ball bearings within the female coupler 164 are released from a groove or retracted to release the male plug 162 secured therein. Movement of the male plug 162 relative to the female coupler 164 causes wear to the quick connect fitting 160, such as to the locking mechanism that secures the male plug 162 to the female coupler 164, and such wear may cause leaks or an unintentional release of the male plug 162 from the female coupler 164.

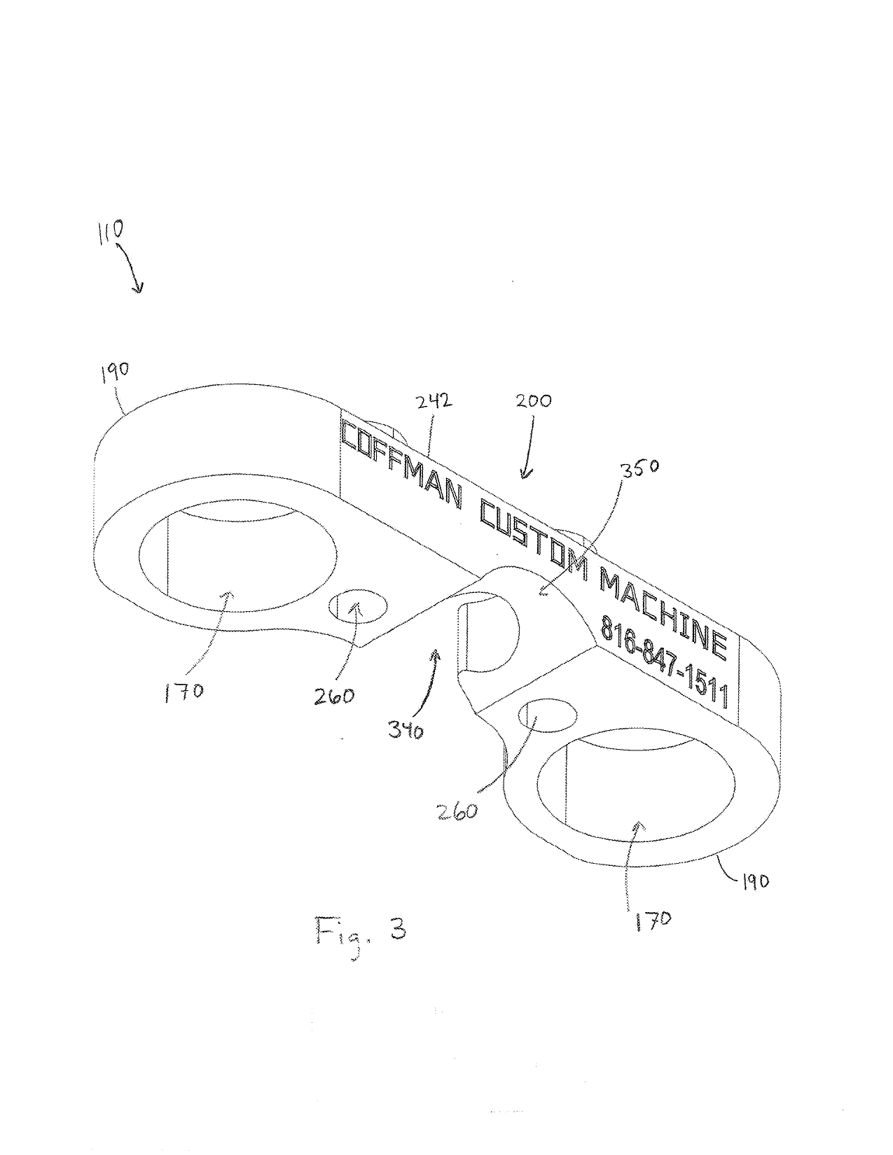

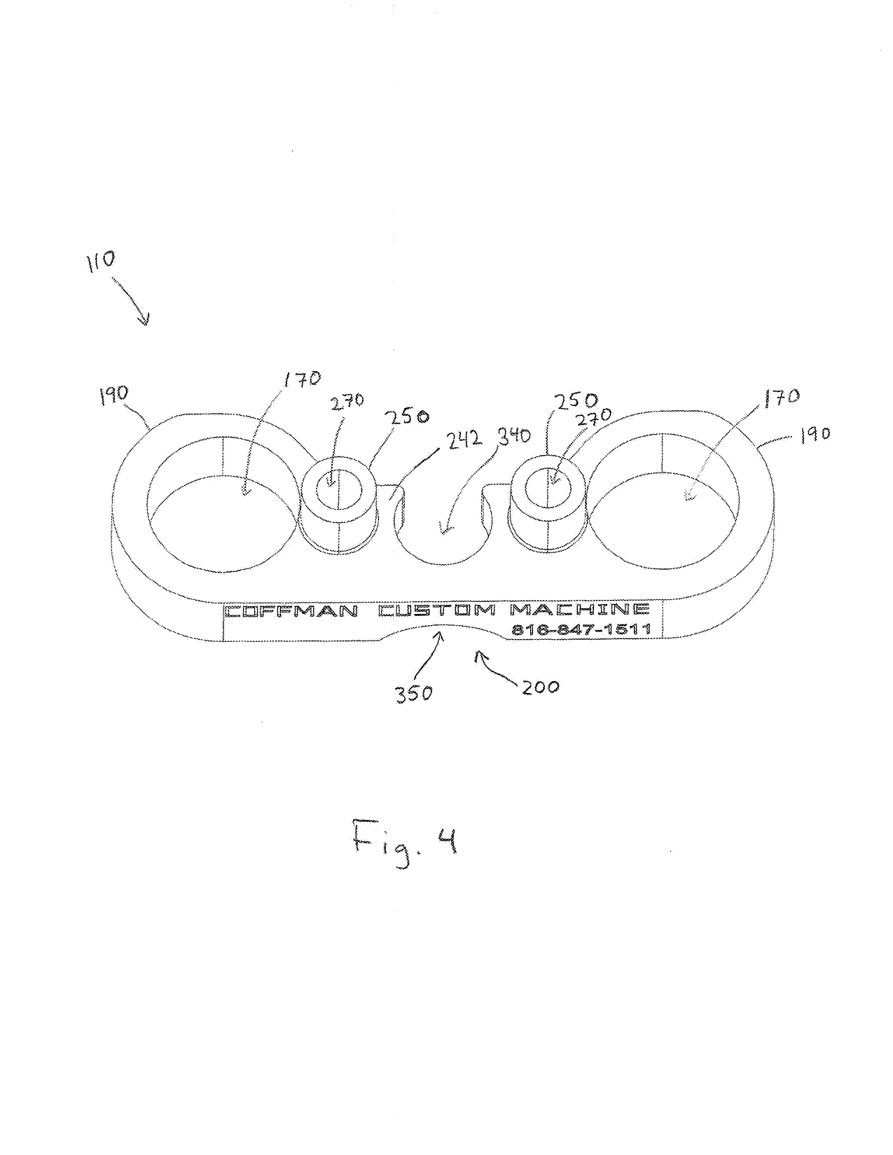

In an embodiment shown in FIGS. 3 and 4, the first bracket 110 is an elongate support member formed with two female coupler receiving bores 170 extending therethrough. The bores 170 are sized to snugly, or removably and securely, receive the female couplers 164 connected to a respective one of the first or second conduits 150a and 150b. The first bracket 110 includes two annular support walls 190 through which the two female coupler receiving bores 170 are formed. Each of the support walls 190 is shaped and positioned to engage, or receive, secure and support, the female coupler 164 in a fixed position relative thereto. In the embodiment shown, the support walls 190 extend completely around the female coupler 164 received therein in contact with or in closely spaced relation to confine and restrain or engage and support the female coupler 164 in the fixed position. It is foreseeable that the female coupler 164 may be engaged by a support wall that extends partially therearound or by a support wall that is adjustable, such as, for example, a clamp. In an embodiment, a bridge or web 200 extends between the support walls 190 of the first bracket 110 and positions the female couplers 164, which are in engagement with the support walls 190 and extending through the respective bores 170, relative to each other. The bridge 200 also positions each female coupler 164 relative to the machine.

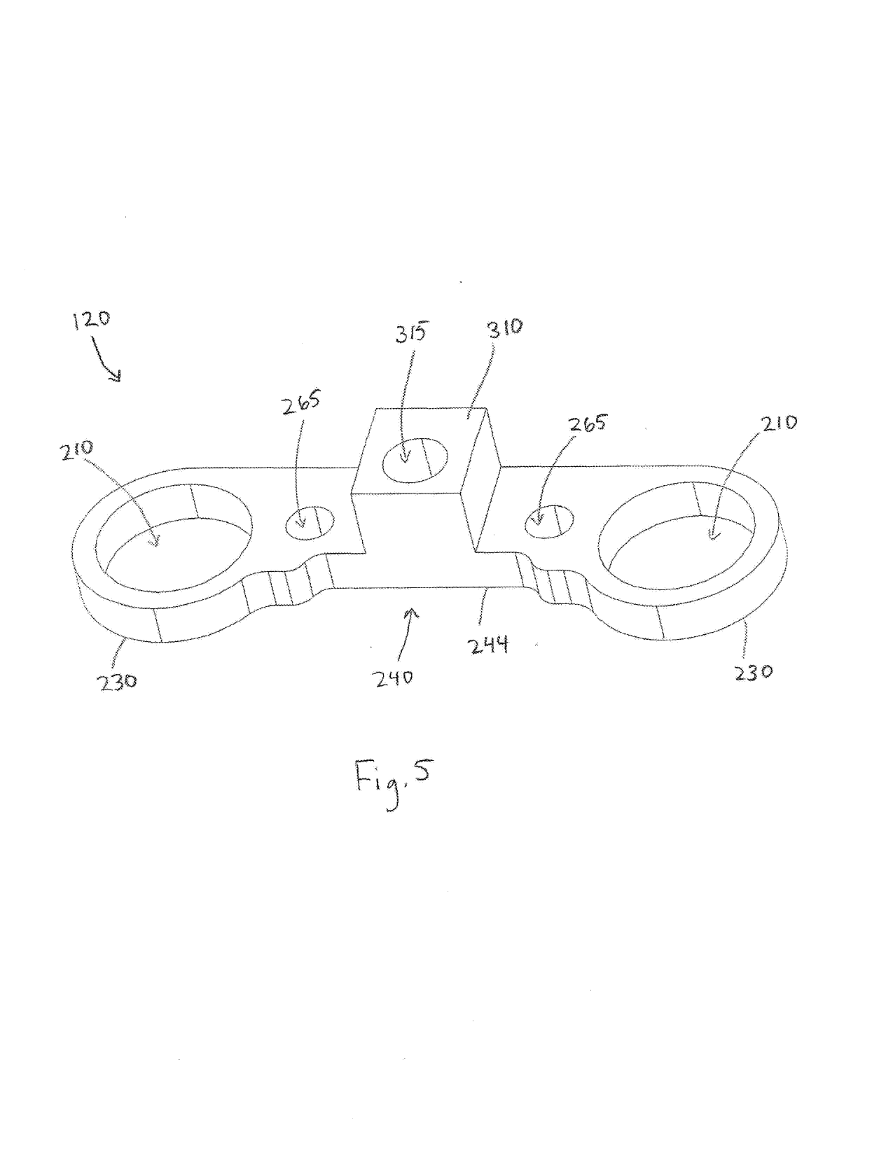

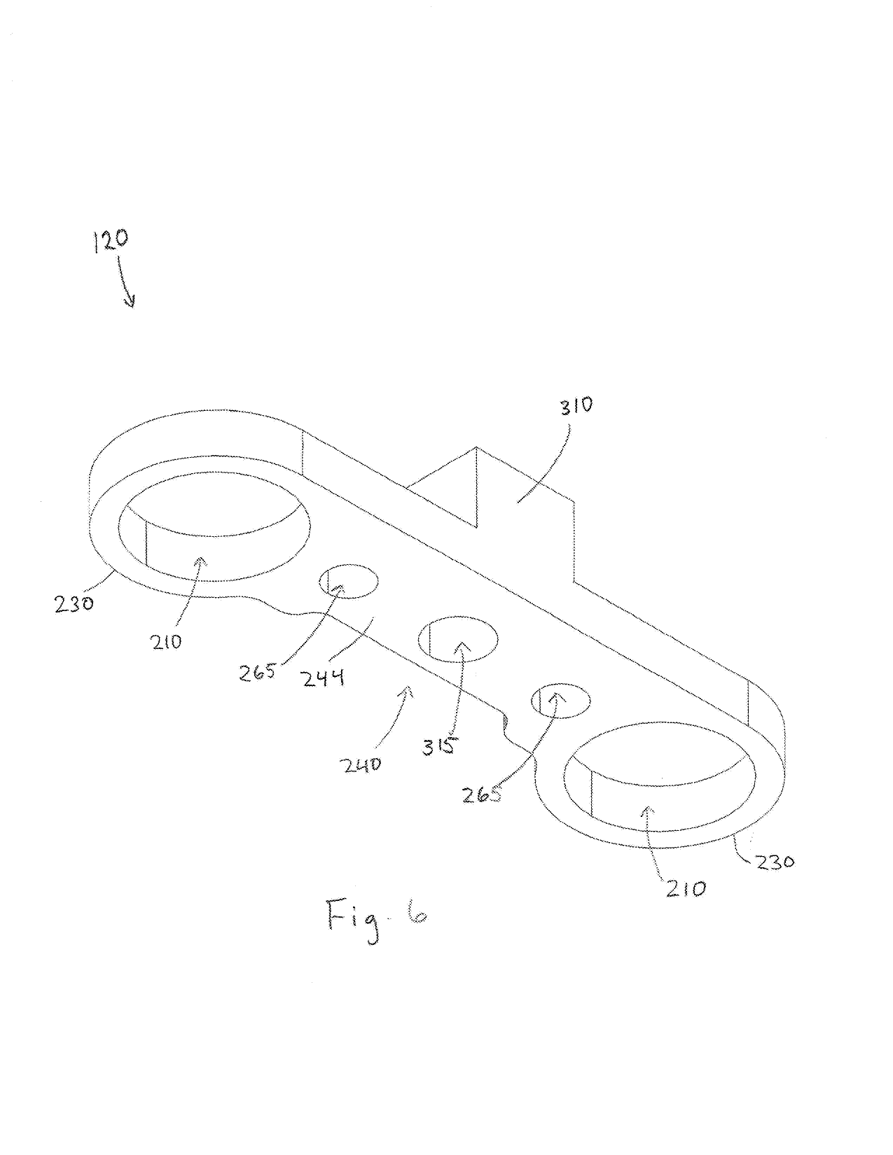

In an embodiment shown in FIGS. 5 and 6, the second bracket 120 is an elongate support member formed with two male coupler receiving bores 210 extending therethrough into which the male plug 162 of respective ones of the quick connect fittings 160 may be snugly, or removably and securely, received. In an embodiment, the bores 210 of the second bracket 120 have a smaller diameter than the bores 170 of the first bracket 110. The second bracket 120 includes two annular support walls 230 through which the respective male coupler receiving bores 210 are formed. Each of the support walls 230 is shaped and positioned to engage, or receive, secure and support, the adapter or fitting 163 of the male plug 162 such that the male plug 162 is secured in a fixed position relative thereto. In the embodiment shown, the support walls 230 extend completely around a respective one of the male plugs 162 inserted through the associated bore 210 and in closely spaced relation to confine and restrain or engage and support the male plug 162 in the fixed position. It is foreseeable that the male plug 162 may be engaged by a support wall that extends partially therearound or by a support wall that is adjustable, such as, for example, a clamp. In an embodiment, a bridge or web 240 extends between the support walls 230 of the second bracket 120 and positions the male plugs 162, which are in engagement with the support walls 230 and extending through the respective bores 210, relative to each other. The bridge 240 also positions each male plug 162 relative to the machine.

It is understood that the number of bores and support walls formed in each bracket could be varied depending on the number of conduit couplers to be secured in place by the fitting stabilizer assembly utilized, including one, two, or more conduit couplers. Each bracket of the fitting stabilizer assembly could include one or more bores each surrounded by a support wall such that each bracket includes one or more support walls. It is foreseeable that the quick connect fitting 160 may be modified such that the female coupler 164 is connected to the entry or exit port of the machine and the male plug 162 is connected to the conduit 150. In such an embodiment, the support walls 190 of the first bracket 110 would be configured to engage a male plug 162 and the support walls 230 of the second bracket 120 would be configured to engage a female coupler 164.

A first or upper surface 242 of the first bracket 110 and a second or lower surface 244 of the second bracket 120 are directed toward each other, and one or more spacers 250 extend therebetween such that the first bracket 110 and the second bracket 120 are spaced apart a distance defined by the one or more spacers 250. In FIG. 4, two spacers 250 are coupled to the first bracket 110, but it is foreseeable that the spacers 250 may be coupled to the second bracket 120 or that the spacers 250 may be an independent component of the fitting stabilizer assembly 100. The spacers 250 may be secured to the first bracket 110 and/or the second bracket 120 by mechanical means or may be formed integrally with the first bracket 110 and/or the second bracket 120. The spacers 250 between the first bracket 110 and the second bracket 120 position the support walls 190 of the first bracket 110 to support the female couplers 164 in engagement with or sealingly secured to or in alignment with the one or more male plugs 162, which are supported by the support walls 230 of the second bracket 120. The spacing maintained between the first and second brackets 110 and 120 by the spacers 250 corresponds to a spacing required between the fixed position of the male plug 162 and the fixed position of the female coupler 164 when coupled together.

The fitting stabilizer assembly 100 secures the position of the female coupler 164 relative to the position of the male plug 162 such that movement of the male plug 162 relative to the female coupler 164, or movement of the female coupler 164 relative to the male plug 162, due to movement or vibration of the machine is minimized or eliminated. More specifically, the support walls 190 and 230 are positioned in closely spaced relation to and securely around the respective coupler 162 and 164 to restrain the couplers 162 and 164 from lateral and longitudinal movement relative to a longitudinal axis thereof. The longitudinal axis is the axis through each of the couplers 162 and 164 in coupling relationship. In an embodiment, the support walls 230 of the second bracket 120 support the adapter or fitting 163 of the male plugs 162 secured within the respective bores 210, and the male plugs 162 are sealingly secured within in the female couplers 164 that are secured within the respective bores 170 formed in the support walls 190 of the first bracket 110.

In an embodiment, the fasteners 130 extend through the spacers 250 to secure the first bracket 110 to second bracket 120. Specifically, the fasteners 130 extend through apertures 260 and 265 formed in the first bracket 110 and the second bracket 120, respectively, and through an aperture 270 formed extending through the spacers 250. In an embodiment shown in FIG. 1, the fasteners 130 are threaded fasteners that threadingly secure the second bracket 120 to the first bracket 110 and include a head 290 that is in engagement with the first bracket 110 and a shank 300 that is at least partially threaded and in engagement with threads extending within at least the second bracket 120.

The second bracket 120 includes a support or mounting boss 310 through which the coupling bolt 140 extends for use in securing or positioning the fitting stabilizer assembly 100 relative to the machine. The 310// may also be referred to as a reinforcement portion. In an embodiment, the mounting boss 310 is formed integral with the bridge 240 and strengthens and stiffens the second bracket 120 to minimize torquing or other deformations or movement of the fitting stabilizer assembly 100 during movement of the machine.

As shown in FIG. 1, the coupling bolt or connector 140 extends through an aperture 315 formed in the reinforcement portion 310. The coupling bolt 140 is a shoulder-type screw or bolt that includes a head 320, a shoulder 325, and a threaded portion 330. The coupling bolt 140 extends through the mounting boss 310 to secure the second bracket 120 between the head 320 and the machine. The head 320 engages the lower surface 244 of the second bracket 120, and the threaded portion 330 threadingly secures the fitting stabilizer assembly 100 to a bolt hole 335 (see FIG. 2) formed in the base pedestal 147 of the machine. In an embodiment, the shoulder 325 does not have threads and extends through the reinforcement portion 310 such that the fitting stabilizer assembly 100 is rotatably secured therein.

The fitting stabilizer assembly 100 is formed to provide clearance for components or portions of the machine and/or for a user to access the coupling bolt 140 of the fitting stabilizer assembly 100. The bridge 200 of the first bracket 110 is formed with a channel or recess 340 through which the coupling bolt 140 is able to advance through when being removed from or inserted into the reinforcement portion 310 of the second bracket 120. The recess 340 may also provide clearance for components of the machine. Further, the bridge 200 may be formed with one or more recesses or grooves 350 that provide clearance for components of the machine. The recesses 350 may also enable a user to reach portions of the fitting stabilizer assembly 100 and the machine.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the claims.

What is claimed is:

1. A fitting stabilizer assembly for securing one or more conduits to a machine, the fitting stabilizer assembly comprising:
a first bracket that supports a first portion of one or more coupling assemblies, the one or more coupling assemblies connecting the one or more conduits to the machine;
a second bracket that supports a second portion of the one or more coupling assemblies;
a coupling connector on one of the first bracket or the second bracket and connectable to the machine; wherein:
the first bracket supports the first portion of the one or more coupling assemblies in alignment with the second portion of the one or more coupling assemblies.

2. The fitting stabilizer assembly of claim 1, further comprising one or more spacers that position the first bracket in spaced relation relative to the second bracket.

3. The fitting stabilizer assembly of claim 1, wherein the first bracket includes one or more first support walls each having a first bore formed therethrough, and the one or more first support walls are positionable such that the first portion of the one or more coupling assemblies extends within the first bore of a respective one of the one or more first support walls.

4. The fitting stabilizer assembly of claim 1, wherein the second bracket includes one or more second support walls each having a second bore formed therethrough, and the one or more second support walls are positionable such that the second portion of the one or more coupling assemblies extends within the second bore of a respective one of the one or more second support walls.

5. The fitting stabilizer assembly of claim 1, wherein the coupling connector is removably securable to the machine for securing the fitting stabilizer assembly to the machine.

6. The fitting stabilizer assembly of claim 1, wherein the second bracket comprises a mounting boss through which the coupling connector extends.

7. The fitting stabilizer assembly of claim 1, wherein the first bracket is formed with one or more first bores that have a first diameter greater than a second diameter of one or more second bores formed in the second bracket.

8. A fitting stabilizer assembly for securing male couplers and female couplers for coolant supply and return conduits relative to a machine, the fitting stabilizer assembly comprising:
a first bracket having first and second first bracket bores formed therein, the first and second first bracket bores each surrounded by a first bracket support wall and having a diameter sized to snugly receive one of the male couplers therein;
a second bracket having first and second second bracket bores formed therein, the first and second second bracket bores each surrounded by a second bracket support wall and having a diameter sized to snugly receive one of the female couplers therein;
a coupling connector on the fitting stabilizer assembly and connectable to the machine; and
at least one connector for connecting the first bracket to the second bracket such that the first bracket bores in the first bracket are axially aligned with the second bracket bores in the second bracket.

9. The fitting stabilizer assembly of claim 8, further comprising one or more spacers that position the first bracket support walls in spaced relation relative to the second bracket support walls.

10. The fitting stabilizer assembly of claim 8, further comprising a mounting boss extending from the fitting stabilizer assembly, wherein the coupling connector extends through the mounting boss.

11. The fitting stabilizer assembly of claim 8, wherein the first and second first bracket bores have a first diameter that is greater than a second diameter of the first and second second bracket bores.

12. A fitting stabilizer assembly for securing one or more conduits to a machine, the fitting stabilizer assembly comprising:
a lower bracket that includes one or more first support walls each positionable in closely spaced relation to a first portion of one or more coupling assemblies connected to the one or more conduits;
an upper bracket that includes one or more second support walls each positionable in closely spaced relation to a second portion of the one or more coupling assemblies; and
one or more spacers extending between the lower bracket and the upper bracket, wherein a spacing maintained by the one or more spacers between the lower bracket and the upper bracket corresponds to a coupling assembly spacing between the first portion and the second portion of the one or more coupling assemblies.

13. The fitting stabilizer assembly of claim 12, further comprising a coupling bolt extending from the fitting stabilizer assembly for securing the fitting stabilizer assembly to the machine.

14. The fitting stabilizer assembly of claim 12, wherein the one or more first support walls of the lower bracket form one or more first bores within which the first portion of the one or more coupling assemblies is supported.

15. The fitting stabilizer assembly of claim 12, wherein the one or more second support walls of the upper bracket form one or more second bores within which the second portion of the one or more coupling assemblies is supported.

16. The fitting stabilizer assembly of claim 12, wherein the first portion and the second portion of the one or more coupling assemblies are supported in coupling relationship.

17. The fitting stabilizer assembly of claim 12, further comprising a mounting boss extending from the upper bracket for securing the fitting stabilizer assembly to the machine.
